(19) United States
(12) Patent Application Publication
(10) Pub. No.: US 2025/0214559 A1
(43) Pub. Date: Jul. 3, 2025

(54) ELECTRIC VEHICLE AND METHOD OF CONTROLLING THE SAME

(71) Applicants: Hyundai Motor Company, Seoul (KR); Kia Corporation, Seoul (KR); HYUNDAI WIA CORPORATION, Changwon-si (KR)

(72) Inventors: Tae Hyung LEE, Hwaseong-Si (KR); Siyoung SONG, Hwaseong-SI (KR); Taewoo LEE, Hwaseong-Si (KR); Jong Chan LEE, Hanam-Si (KR)

(73) Assignees: Hyundai Motor Company, Seoul (KR); Kia Corporation, Seoul (KR); HYUNDAI WIA CORPORATION, Changwon-si (KR)

(21) Appl. No.: 18/882,528

(22) Filed: Sep. 11, 2024

(30) Foreign Application Priority Data
Dec. 29, 2023 (KR) 10-2023-0197136

(51) Int. Cl. B60W 10/12

(52) U.S. Cl. CPC B60W 10/12; B60W 2540/10; B60W 2552/05

(57) ABSTRACT

In an electric vehicle and a method of controlling the same, the electric vehicle may include: a drive motor generating power required for driving a vehicle; a first limited slip differential limiting a differential action by a first differential apparatus mounted on a first driveshaft; a second limited slip differential limiting the differential action by a second differential apparatus mounted on a second driveshaft; and a controller controlling a control sensitivity of the drive motor, and control amounts of the first limited slip differential and the second limited slip differential according to a driving mode of the vehicle.

### CROSS-REFERENCE TO RELATED APPLICATION

The present application claims priority to Korean Patent Application No. 10-2023-0197136 filed on Dec. 29, 2023, the entire contents of which is incorporated herein for all purposes by this reference.

### BACKGROUND OF THE PRESENT DISCLOSURE

### Field of the Present Disclosure

The present disclosure relates to an electric vehicle and a method of controlling the same, and more particularly, to an electric vehicle and a method of controlling the same which can easily escape from a rough road through limited slip differentials provided on a front driveshaft and a rear driveshaft, respectively.

### Description of Related Art

A limited slip differential (LSD) synchronizes a left wheel and a right wheel to limit a differential action caused by a differential apparatus.

In related art, the LSD is generally installed only on a main driveshaft (e.g., a rear driveshaft of a rear-wheel driving vehicle).

When the LSD is installed only on the main driveshaft, a vehicle can easily escape from a rough road in a situation in which the vehicle is driven on a flat straight road. However, there is a problem in that a differential limitation performance of the LSD of the vehicle cannot be sufficiently shown in a certain terrain (e.g., a bumpy road or a road with a big difference in friction coefficient of diagonal wheels). Furthermore, in the case of an electric vehicle, because an increase rate of an output velocity of a drive motor is very fast, when the drive motor utilizes a maximum output in the rough road, the vehicle can still be disadvantageous in escaping the rough road.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric vehicle configured for easily escaping from a rough road, and a method of controlling the same.

An electric vehicle exemplary embodiment of the present disclosure may include: a drive motor generating power required for driving a vehicle; a first limited slip differential limiting a differential action by a first differential apparatus mounted on a first driveshaft; a second limited slip differential limiting the differential action by a second differential apparatus mounted on a second driveshaft; and a controller operatively connected to the drive motor, the first limited slip differential and the second first limited slip differential and configured for controlling a control sensitivity of the drive motor, and control amounts of the first limited slip differential and the second limited slip differential according to a driving mode of the vehicle.

In some exemplary embodiments of the present disclosure, the driving mode may include a normal driving mode, a snowy road driving mode, a sand road driving mode, a muddy road driving mode, and a rough road driving mode.

In some exemplary embodiments of the present disclosure, when the driving mode is the rough road driving mode, the controller may reduce the control sensitivity of the drive motor.

In some exemplary embodiments of the present disclosure, the control sensitivity may mean an output change amount of the drive motor according to a change of an opening level of an accelerator pedal.

In some exemplary embodiments of the present disclosure, the controller may set the control sensitivity in the rough road driving mode to be smaller than a control sensitivity in the muddy road driving mode, a control sensitivity in the normal driving mode, and a control sensitivity in the snowy road driving mode.

In some exemplary embodiments of the present disclosure, when the driving mode is the rough road driving mode, the controller may set the control amounts of the first limited slip differential and the second limited slip differential to be the maximum.

In some exemplary embodiments of the present disclosure, the control amounts of the first limited slip differential and the second limited slip differential may mean clutch toques.

In some exemplary embodiments of the present disclosure, the controller may set the control sensitivity in the rough road driving mode to be greater than the control sensitivity in the muddy road driving mode, the control sensitivity in the normal driving mode, and the control sensitivity in the snowy road driving mode.

In some exemplary embodiments of the present disclosure, when the driving mode is the rough road driving mode, the controller may turn off an electronic stability control apparatus.

Another exemplary embodiment of the present disclosure provides a method of controlling an electric vehicle, which may include: determining, by a controller, a driving mode of a vehicle; and reducing, by the controller, a control sensitivity of a drive motor, and setting clutch torques of a first limited slip differential and a second limited slip differential to the maximum torque when the driving mode of the vehicle is a rough road driving mode.

In some exemplary embodiments of the present disclosure, the driving mode may include a normal driving mode, a snowy road driving mode, a sand road driving mode, a muddy road driving mode, and a rough road driving mode.

In some exemplary embodiments of the present disclosure, the control sensitivity may mean an output change amount of the drive motor according to a change of an opening level of an accelerator pedal.

In some exemplary embodiments of the present disclosure, the control sensitivity in the rough road driving mode may be set to be smaller than a control sensitivity in the muddy road driving mode, a control sensitivity in the normal driving mode, and a control sensitivity in the snowy road driving mode.

In some exemplary embodiments of the present disclosure, the control sensitivity in the rough road driving mode may be set to be greater than the control sensitivity in the muddy road driving mode, the control sensitivity in the normal driving mode, and the control sensitivity in the snowy road driving mode.

In some exemplary embodiments of the present disclosure, when the driving mode is the rough road driving mode, an electronic stability control apparatus may be turned off.

According to exemplary embodiments of the present disclosure, when a driving mode of a vehicle is a rough road driving mode, a torque of a drive motor is gradually increases, and clutch torques of first and second LSDs are set to a maximum torque, so that the vehicle can rapidly escape from a rough road.

Besides, an effect which may be obtained or predicted by the exemplary embodiment of the present disclosure is directly or implicitly included in detailed description of the exemplary embodiment of the present disclosure. That is, various effects predicted according to the exemplary embodiment of the present disclosure will be included in the detailed description to be described below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a conceptual diagram illustrating a configuration of an electric vehicle according to an exemplary embodiment of the present disclosure.

FIG. 2 is a block diagram illustrating the configuration of the electric vehicle according to an exemplary embodiment of the present disclosure.

FIG. 3 is a conceptual diagram illustrating a configuration of a differential apparatus and a limited slip differential according to an exemplary embodiment of the present disclosure.

FIG. 4 is a flowchart illustrating a method of controlling an electric vehicle according to an exemplary embodiment of the present disclosure.

FIG. 5 is a diagram describing a control method depending on with a driving mode according to an exemplary embodiment of the present disclosure.

FIG. 6A and FIG. 6B are diagrams illustrating a configuration of a display unit of the electric vehicle according to an exemplary embodiment of the present disclosure.

FIG. 7 and FIG. 8 are diagrams describing an effect of the electric vehicle according to an exemplary embodiment of the present disclosure.

FIG. 9 is a diagram describing a computing device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terms used here are only for describing specific exemplary embodiments of the present disclosure, and are not intended to limit the present disclosure. As used here, the singular forms are also intended to include plural forms, unless they are explicitly differently indicated by context. It will be appreciated that when terms “include” and/or “including” are used in the present specification, the terms “include” and/or “including” are intended to designate the existence of mentioned features, integers, steps, operations, constituent elements, and/or components, but do not exclude the existence or addition of one or more other features, integers, steps, operations, constituent elements, and components, and/or groups thereof. As used here, the terms “and/or” include any one or all combinations of the items which are associated and listed.

Additionally, it is appreciated that one or more or at least one of the following methods or aspects thereof may be executed by at least one controller. The term “controller” may refer to a hardware device including a memory and a processor. The memory is configured to store program instructions, and the processor is particularly programmed to execute the program instructions to perform one or more processes which are described below in more detail. As disclosed here, the controller may be configured for controlling units, modules, parts, apparatuses, or operations of those similar thereto. Furthermore, as recognized by those skilled in the art, it is appreciated that the following methods may be executed by an apparatus including the controller jointly with one or more other components.

Furthermore, the controller of the present disclosure may be implemented as a non-transitory computer readable recording medium including executable program instructions executed by the processor. Examples of computer readable recording media include a ROM, a RAM, a compact disk (CD) ROM, magnetic tapes, floppy disks, flash drives, smart cards, and optical data storage devices, but are not limited thereto. The computer readable recording media are also distributed throughout a computer network, and program instructions may be stored and executed by a distribution scheme such as a telematics server or a Controller Area Network (CAN).

The present disclosure will be described in detail to be easily conducted by those skilled in the art in a field of the present disclosure to which the present disclosure pertains. However, the present disclosure may be realized in various different forms, and is not limited to the exemplary embodiments described herein.

A part irrelevant to the description will be omitted to clearly describe the present disclosure, and the same elements will be designated by the same reference numerals throughout the specification.

Furthermore, because size and thickness of each component illustrated in the drawings are arbitrarily represented for convenience in explanation, the present disclosure is not particularly limited to the illustrated size and thickness of each component and the thickness is enlarged and illustrated to clearly express various parts and areas.

Suffixes “module” and/or “unit” for components used in the following description are provided or mixed in consideration of easy preparation of the present disclosure only and do not have their own distinguished meanings or roles.

Furthermore, in describing a disclosed exemplary embodiment of the present disclosure, a detailed description of related known technologies will be omitted if it is determined that the detailed description makes the gist of the exemplary embodiment of the present disclosure unclear.

Furthermore, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms.

In the description below, the expression described by the singular may be interpreted as a singular or plurality, unless an explicit expression such as “one” or “single” is used.

The terms are used only to discriminate one component from another component.

In the flowchart described with reference to the drawings, the order of operations may be changed, multiple operations may be merged, or any operation may be divided, and a specific operation may not be performed.

Hereinafter, an electric vehicle according to an exemplary embodiment of the present disclosure will be described in detail with reference to the accompanying drawings.

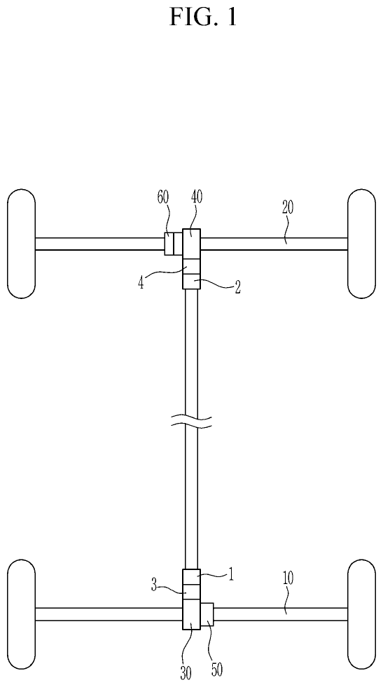

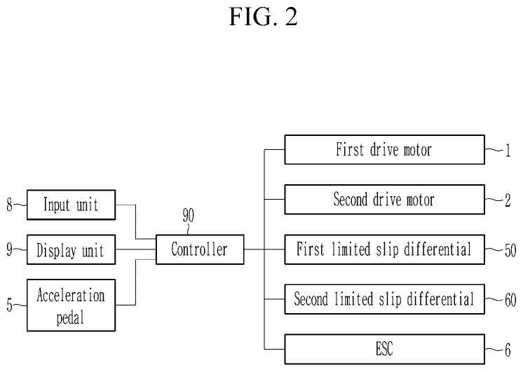

FIG. 1 is a conceptual diagram illustrating a configuration of an electric vehicle according to an exemplary embodiment of the present disclosure. Furthermore, FIG. 2 is a block diagram illustrating the configuration of the electric vehicle according to an exemplary embodiment of the present disclosure.

As illustrated in FIG. 1 and FIG. 2, the electric vehicle according to various exemplary embodiments of the present disclosure may include a drive motor, a first LSD 50 provided on a first driveshaft 10, a second LSD 60 provided on a second driveshaft 20, and a controller 90 controlling a control sensitivity of the drive motor, and control amounts of the first LSD 50 and the second LSD 60 according to a driving mode of a vehicle.

The drive motor may be configured to generate power required for driving the electric vehicle according to an exemplary embodiment of the present disclosure. The drive motor may be an electric motor that generates power by electrical energy. The drive motor may include a first drive motor 1 and a second drive motor 2.

Power generated by the first drive motor 1 may be transmitted to a left wheel and a right wheel of the first driveshaft 10 (e.g., a rear driveshaft or a main driveshaft) through a first decelerator 3 and the first differential apparatus 30. Furthermore, power generated by the second drive motor 2 may be transmitted to a left wheel and a right wheel of the second driveshaft 20 (e.g., a front driveshaft or an auxiliary driveshaft) through a second decelerator 4 and the second differential apparatus 40.

The first LSD 50 may be provided on the first driveshaft 10 (e.g., the rear driveshaft), and may limit a differential action by the first differential apparatus 30 provided on the first driveshaft 10.

The first differential apparatus 30 may allow the left wheel and the right wheel provided on the first driveshaft 10 to rotate at different velocities. The first differential apparatus 30 generates a difference in rotational velocity between a turn internal wheel and a turn external wheel when the vehicle turns.

The first LSD 50 may limit the differential action of the left wheel and the right wheel generated by the first differential apparatus 30. That is, the first LSD 50 may synchronize the left wheel and the right wheel of the first driveshaft 10 to thereby limit the difference in velocity between the left wheel and the right wheel. The first LSD 50 may be an electric limited slip differential (eLSD).

The second LSD 60 may be provided on the second driveshaft 20 (e.g., the front driveshaft), and may limit the differential action by the second differential apparatus 40 provided on the second driveshaft 20.

The second differential apparatus 40 may allow the left wheel and the right wheel provided on the second driveshaft 20 to rotate at different velocities. The second differential apparatus 40 generates a difference in rotational velocity between the turn internal wheel and the turn external wheel when the vehicle turns.

The second LSD 60 may limit the differential action of the left wheel and the right wheel generated by the second differential apparatus 40. That is, the second LSD 60 may synchronize the left wheel and the right wheel of the second driveshaft 20 to thereby limit the difference in velocity between the left wheel and the right wheel. The second LSD 60 may be an electric limited slip differential (eLSD).

The first LSD 50 and the second LSD 60 may synchronize the left wheel and the right wheel through a clutch 70 when the velocity difference between the left wheel and the right wheel is generated.

The clutch 70 may include a clutch plate 71 and a friction plate 73. The clutch plate 71 may be connected to side gears (or dip gears) 33 of the first and second differential apparatuses 30, 40, and the friction plate 73 of the clutch 70 may be connected to a differential case 31. Accordingly, when the first and second LSDs 50 and 60 are actuated, the left wheel and the right wheel may be synchronized by torques applied to the clutch plate 71 and the friction plate 73 of the clutch 70.

When a maximum torque is applied to the clutches 70 of the first and second LSDs 50 and 60, the left and right wheels are completely synchronized, and the left and right wheels rotate at the same velocity. In the instant case, the first and second differential apparatus 30, 40 are actuated as a lock-up differential.

When no torque is applied to the clutches 70 of the first and second LSDs 50 and 60, the left and right wheels are not synchronized, and the left and right wheels rotate at different velocities according to a driving situation. In the instant case, the first and second differential apparatuses 40 are actuated as an open differential.

The controller 90 may be configured for controlling a control sensitivity of the drive motor, and control amounts of the first LSD 50 and the second LSD 60 according to the driving mode of the vehicle. The controller 90 may include a first controller 90 controlling the drive motor, and a second controller 90 controlling the first and second LSDs 50 and 60. The first controller 90 and the second controller 90 may be integrated into one controller 90, and distributed as necessary. In an exemplary embodiment of the present disclosure, it is described that the first controller 90 and the second controller 90 are integrated.

To the present end, the controller 90 may be implemented as one or more processors which operate by a set program, and a memory of the controller 90 stores program instructions programmed to perform each step of the method of controlling the electric vehicle according to an exemplary embodiment of the present disclosure through one or more processors.

The driving mode of the vehicle may include a normal driving model, a snowy road driving mode, a sand road driving mode, a muddy road driving mode, and a rough road driving mode.

The snowy road driving mode may mean a driving mode which prevents the vehicle from sliding on a slippery road such as a snowy road.

The sand road driving mode may mean a driving mode for the vehicle to escape from the sand road.

The muddy road driving mode may mean a driving mode for the vehicle to escape from a muddy road.

The rough road driving mode may mean a driving mode for the vehicle to escape from a rough road. In an exemplary embodiment of the present disclosure, a road on which the vehicle is driven is an uphill road, and the rough road may mean a road (hereinafter, referred to as ‘a diagonal offset friction slope’ as necessary) in which a friction coefficient of a road surface on which the front left wheel (or front right wheel) is grounded and a friction coefficient of a road surface on which the rear right wheel (or rear left wheel) is grounded are different. Alternatively, in the case of the rough road, the road on which the vehicle is driven is the uphill road, and the road surface is rugged.

The normal driving mode may mean a driving mode of the vehicle other than a special driving mode such as the snowy road driving mode, the sand road driving mode, the muddy road driving mode, and the rough road driving mode.

The driving mode of the vehicle may be selected by an input of the driver. That is, the driver may select the driving mode through an input unit 8 provided in the vehicle.

The control sensitivity of the drive motor may mean an output change amount (or a torque change amount) of the drive motor according to a change an opening level of an acceleration pedal 5, and the control amounts of the first and second LSDs 50 and 60 may mean clutch torques of the first and second LSDs 50 and 60.

When the driving mode of the vehicle is the rough road driving mode, the controller 90 may reduce the control sensitivity of the drive motor, and control the clutch torques of the first and second LSDs 50 and 60 to become a maximum torque.

As the control sensitivity of the drive motor becomes smaller, the output change amount of the drive motor according to the change of the opening level of the accelerator pedal may be reduced. In the instant case, an output change amount (or a torque change amount) of the drive motor may be reduced with respect to the same change of the opening level of the accelerator pedal 5.

As the control sensitivity of the drive motor increases, the output change amount of the drive motor according to the change of the opening level of the accelerator pedal may increase. In the instant case, the output change amount (or the torque change amount) of the drive motor may increase with respect to the same change of the opening level of the accelerator pedal.

When the maximum torque is applied as the clutch torques of the first and second LSDs 50 and 60, the left wheel and the right wheel of the first driveshaft 10 may be completely synchronized, and the left wheel and the right wheel of the second driveshaft 20 may be completely synchronized.

The vehicle according to various exemplary embodiments of the present disclosure may further include a display unit 9 that displays operations states of the first LSD 50 and the second LSD 60. The display unit 9 may be implemented through a center fascia or a cluster provided in the vehicle.

The operation states of the first LSD 50 and the second LSD 60 are provided through the display unit 9, so that the driver may intuitively easily determine current driving information.

The electric vehicle according to various exemplary embodiments of the present disclosure may include an electronic stability control apparatus 6. The ESC apparatus 6 may secure the driving stability of the vehicle by automatically controlling each wheel of the vehicle independently without separate braking by the driver in link with an anti-lock brake system (ABS) and a traction control system (TCS) as a system for stably controlling an overall driving posture of the vehicle.

Hereinafter, the method of controlling the electric vehicle according to an exemplary embodiment will be described in detail with reference to the accompanying drawings.

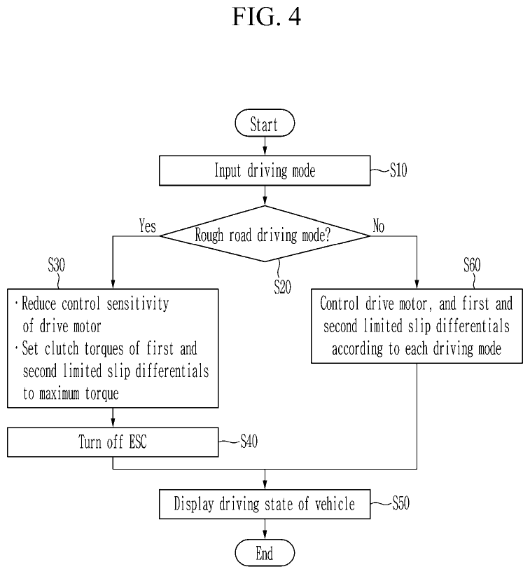

FIG. 4 is a flowchart illustrating a method of controlling an electric vehicle according to an exemplary embodiment of the present disclosure.

Referring to FIG. 4, a driver may select a driving mode of a vehicle through an input unit 8 (S10).

A controller 90 may be configured to determine the driving mode of the vehicle through an input of the driver (S20), and determine a control sensitivity of a drive motor, and clutch torques of first and second LSDs 50 and 60 according to the driving mode of the vehicle.

When the driving mode of the vehicle is a rough road driving mode, the controller 90 may reduce the control sensitivity of the drive motor, and set the control amounts of the first and second LSDs 50 and 60 (the clutch torques of the first and second LSDs 50 and 60) to a maximum torque (S30).

At the present time, the control sensitivity of the drive motor may mean an output change amount of the drive motor (or a torque change amount of the drive motor) according to a change of an opening level of an accelerator pedal.

As the control sensitivity becomes smaller, an output of the drive motor may be reduced even though the change of the opening level of the accelerator pedal is the same. That is, even though the driver slowly steps on the acceleration pedal, the output of the drive motor may slowly increase.

Contrary to this, when the control sensitivity becomes larger, the output of the drive motor may increase even though the change of the opening level of the accelerator pedal is the same. That is, even though the driver slowly steps on the acceleration pedal, the output of the drive motor may rapidly increase.

When the driving mode of the vehicle is the rough road driving mode, the controller 90 may set the control sensitivity in the rough road driving mode to be smaller than control sensitivities in other driving modes.

That is, the control sensitivity in the rough road driving mode may be set to be smaller than a control sensitivity in a muddy road driving mode, a control sensitivity in a snowy road driving mode, and a control sensitivity in a normal driving mode. As a result, the change of the output of the drive motor is reduced even though the change of the opening level of the accelerator pedal is the same.

Furthermore, when the driving mode of the vehicle is the rough road driving mode, the controller 90 may set the control amounts of the first and second LSDs 50 and 60 to the maximum.

At the present time, the control amounts of the first and second LSDs 50 and 60 may mean clutch torques of the first and second LSDs 50 and 60, and the clutch torques of the first and second LSDs 50 and 60 may be set to the maximum torque.

When the clutch torques of the first and second LSDs 50 and 60 are set to the maximum torque, a left wheel and a right wheel of the first driveshaft 10 may be completely synchronized, and the left wheel and the right wheel of the second driveshaft 20 may be completely synchronized.

Accordingly, in the rough road driving mode, the torque of the drive motor may slowly increase, and the clutch torques of the first and second LSDs 50 and 60 may be set to the maximum torque. As a result, a wheel of the vehicle may be prevented from spinning with no traction or a yaw behavior of the vehicle may be prevented from occurring due to a rapid increase in torque of the drive motor, and as a result, the vehicle may rapidly escape from the rough road.

Meanwhile, when the driving mode of the vehicle is the rough road driving mode, the controller 90 may turn off an electronic stability control apparatus 6 (S40).

In the rough road driving mode, the ESC apparatus 6 is turned off to control the output (e.g., the output of the drive motor, and/or the clutch torques of the first and second LSDs 50 and 60) of the vehicle according to the input (e.g., the opening level of the acceleration pedal, and/or handling of a steering wheel) of the driver to be predicted.

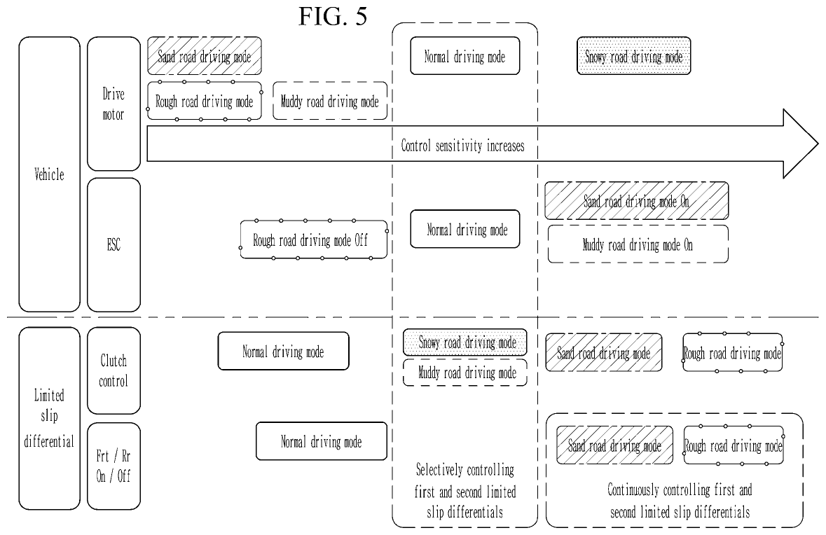

Referring to FIG. 5, the control sensitivities in the rough road driving mode and the sand road driving mode may be the smallest, the control sensitivity in the muddy road driving mode may be relatively large, the control sensitivity in the normal driving mode may be relatively larger, and the control sensitivity in the snowy road driving mode may be set to be the largest.

Furthermore, the ESC apparatus 6 may be turned off in the rough road driving mode, the ESC apparatus 6 may be selectively turned on in the normal driving mode, and the ESC apparatus 6 may be continuously turned on in the sand road driving mode and the muddy road driving mode.

Furthermore, the LSD of the first driveshaft 10 (or main driveshaft) may be selectively actuated in the normal driving mode.

Any one of the LSD of the first driveshaft 10 (or main driveshaft) and the LSD of the second driveshaft 20 (or auxiliary driveshaft) may be selectively actuated in the snowy road driving mode and the muddy road driving mode.

Furthermore, the LSD of the first driveshaft 10 (or main driveshaft) and the LSD of the second driveshaft 20 (or auxiliary driveshaft) may be continuously actuated in the sand road driving mode and the rough road driving mode.

Accordingly, in the rough road driving mode, the output (or torque) of the drive motor may slowly increase by reducing the control sensitivity of the drive motor, and the clutch torques of the first and second LSDs 50 and 60 may be set to the maximum torque to allow the vehicle to rapidly escape from the rough road.

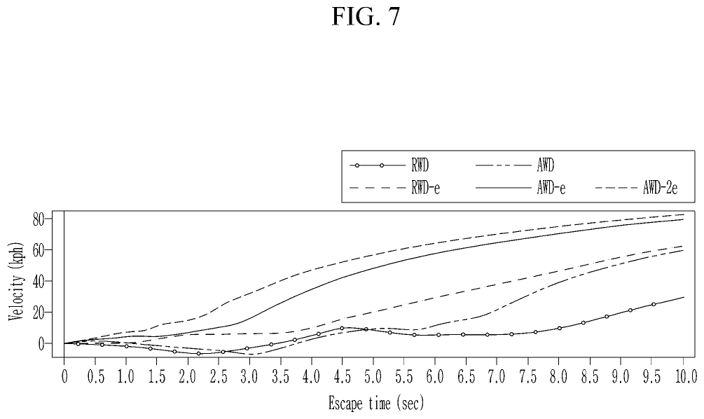

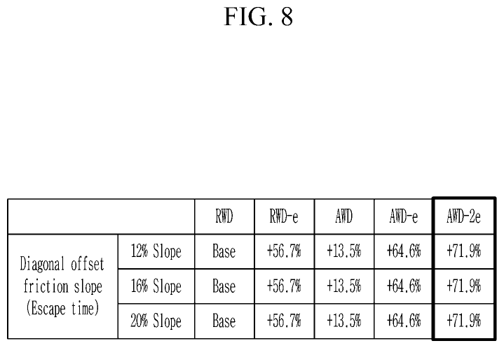

FIG. 7 is a graph showing an escape time on a diagonal offset friction slope including an inclination angle of 20%. Furthermore, FIG. 8 is a table showing escape times on diagonal offset friction slopes having different inclination angles.

Referring to FIGS. 7 and 8, it may be seen that an escape performance of escaping the rough road in an electric vehicle AWD-2e according to an exemplary embodiment of the present disclosure is enhanced by a maximum of 22.3% compared to the rear wheel driving vehicle (RWD) with no LSD, the four-wheel driving vehicle (AWD) with no LSD, the rear wheel driving vehicle (RWD-e) with the LSD only on the main driveshaft, and the four-wheel driving vehicle (AWD-e) with the LSD only on the main driveshaft.

Furthermore, it may be seen that the escape time on the diagonal offset friction slope is the fastest in the electric vehicle AWD-2e according to an exemplary embodiment of the present disclosure is enhanced by a maximum of 22.3% compared to a rear wheel driving vehicle (RWD) with no LSD, a four-wheel driving vehicle (AWD) with no LSD, a rear wheel driving vehicle (RWD-e) with the LSD only on the main driveshaft, and a four-wheel driving vehicle (AWD-e) with the LSD only on the main driveshaft.

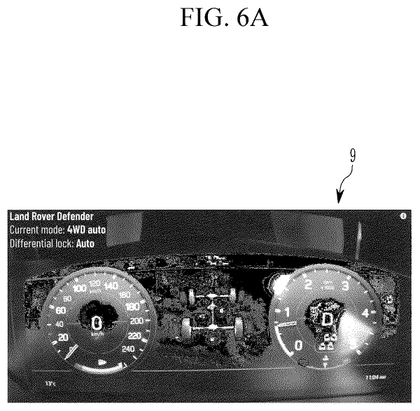

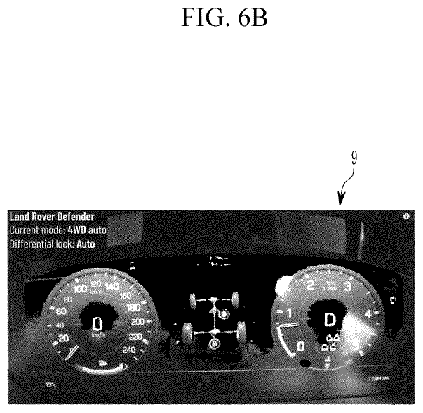

Referring to back to FIG. 5, the controller 90 may display the driving state of the vehicle according to the driving mode of the vehicle through the display unit 9 (S50). The driving state of the vehicle may include operation states of the first and second LSDs 50 and 60, and slip states of the left wheel and the right wheel of each wheel (first driveshaft 10, and the left wheel and the right wheel of the second driveshaft 20) (see FIG. 6A and FIG. 6B).

Accordingly, the driving state of the vehicle is displayed through the display unit 9 according to the driving mode of the vehicle, so that the driver may intuitively confirm that the vehicle is in the rough rod driving state.

When the driving mode of the vehicle is a driving mode other than the rough road driving mode, the controller 90 may be configured for controlling the drive motor, and the first and second LSDs 50 and 60 according to each driving mode (S60). Because the operations of the drive motor and the first and second LSDs 50 and 60 in the driving mode other than the rough road driving mode are already known, a detailed description will be omitted.

According to an exemplary embodiment of the present disclosure, when a driving mode of a vehicle is a rough road driving mode, a torque of a drive motor slowly increases, and clutch torques of the first and second LSDs 50 and 60 are set to a maximum torque, so that the rough road escape performance of the vehicle may be strengthened.

Furthermore, in the rough road driving mode, the ESC apparatus 6 is turned off to predict the output of the vehicle according to the input of the driver.

Furthermore, the driving state of the vehicle is displayed through the display unit 9, so that the driver may intuitively determine the driving state of the vehicle.

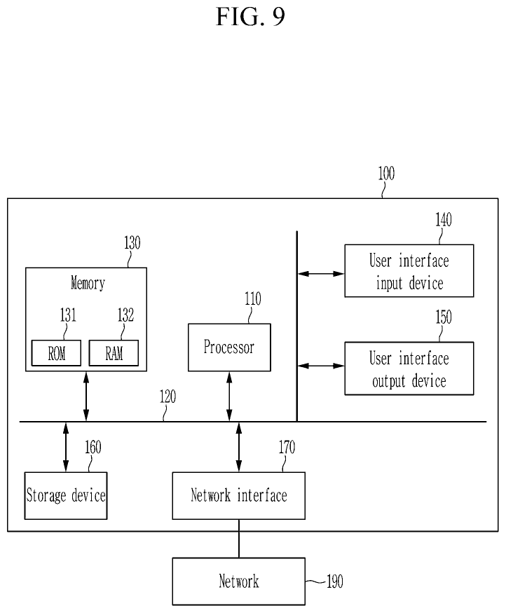

FIG. 9 is a diagram describing a computing device according to an exemplary embodiment of the present disclosure.

Referring to FIG. 9, the method of controlling the electric vehicle according to various exemplary embodiments of the present disclosure may be implemented by use of the computing device 100.

The computing device 100 may include at least one of a processor 110, a memory 130, a user interface input device 140, a user interface output device 150, and a storage device 160 which fluidically-communicate with each other through a bus 120. The computing device 100 may also include a network interface 170 electrically connected to a network 190. The network interface 170 may transmit or receive a signal to or from another entity through the network 190.

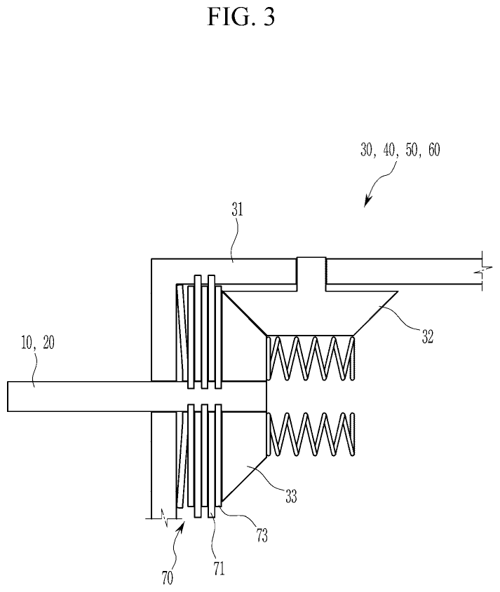

The processor 110 may be implemented as various types including a micro controller unit (MCU), an application processor (AP), a central processing unit (CPU), a graphic processing unit (GPU), and a neural processing unit (NPU), and may be an arbitrary semiconductor device that executes an instruction stored in the memory 130 or the storage device 160. The processor 110 may be configured to implement the functions and methods in relation to FIG. 1, FIG. 2, FIG. 3, FIG. 4, FIG. 5, FIG. 6A and FIG. 6B, FIG. 7, and FIG. 8.

The memory 130 and the storage device 160 may be various types of volatile or non-volatile storage media. For example, the memory may include a read only memory (ROM) 131 and a random access memory (RAM) 132. In the exemplary embodiment of the present disclosure, the memory 130 may be positioned inside or outside the processor 110 and connected to the processor 110 by various well-known means.

In some exemplary embodiments of the present disclosure, at least some components or functions of the electric vehicle and the method of controlling the same according to the exemplary embodiments of the present disclosure may be implemented as a program or software executed by the computing device 100 or the program or software may be stored in a computer readable medium.

In some exemplary embodiments of the present disclosure, at least some components or functions of the method of controlling the electric vehicle according to the exemplary embodiments of the present disclosure may be implemented by use of hardware or a circuit of the computing device 100 or as a separate hardware or circuit which may be electrically connected to the computing device 100.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle comprising:
a drive motor generating power required for driving a vehicle;
a first limited slip differential limiting a differential action by a first differential apparatus mounted on a first driveshaft;
a second limited slip differential limiting the differential action by a second differential apparatus mounted on a second driveshaft; and
a controller operatively connected to the drive motor, the first limited slip differential and the second first limited slip differential and configured for controlling a control sensitivity of the drive motor, and control amounts of the first limited slip differential and the second limited slip differential according to a driving mode of the vehicle.

2. The vehicle of claim 1, wherein the driving mode includes a normal driving mode, a snowy road driving mode, a sand road driving mode, a muddy road driving mode, and a rough road driving mode.

3. The vehicle of claim 2, wherein in response that the driving mode is the rough road driving mode, the controller is further configured to reduce the control sensitivity of the drive motor.

4. The vehicle of claim 3, wherein the control sensitivity means an output change amount of the drive motor according to a change of an opening level of an accelerator pedal.

5. The vehicle of claim 4, wherein the controller is further configured to set the control sensitivity in the rough road driving mode to be smaller than the control sensitivity in the muddy road driving mode, the control sensitivity in the normal driving mode, and the control sensitivity in the snowy road driving mode.

6. The vehicle of claim 2, wherein in response that the driving mode is the rough road driving mode, the controller is further configured to set the control amounts of the first limited slip differential and the second limited slip differential to be a maximum.

7. The vehicle of claim 6, wherein the control amounts of the first limited slip differential and the second limited slip differential mean clutch toques.

8. The vehicle of claim 6, wherein the controller is further configured to set the control sensitivity in the rough road driving mode to be greater than the control sensitivity in the muddy road driving mode, the control sensitivity in the normal driving mode, and the control sensitivity in the snowy road driving mode.

9. The vehicle of claim 1, wherein in response that the driving mode is the rough road driving mode, the controller is further configured to turn off an electronic stability control apparatus.

10. The vehicle of claim 1, further including a display unit that displays operations states of the first LSD and the second LSD.

11. A method of controlling a vehicle, the method comprising:
determining, by a controller, a driving mode of the vehicle; and
controlling, by the controller, a control sensitivity of a drive motor, and control amounts of a first limited slip differential and a second limited slip differential according to the driving mode of the vehicle.

12. The method of claim 11, wherein the driving mode includes a normal driving mode, a snowy road driving mode, a sand road driving mode, a muddy road driving mode, and a rough road driving mode.

13. The method of claim 12, further including:
reducing, by the controller, the control sensitivity of the drive motor operatively connected to the controller, and setting clutch torques of the first limited slip differential and the second limited slip differential operatively connected to the controller, to a maximum torque in response that the driving mode of the vehicle is the rough road driving mode.

14. The method of claim 13, wherein the control sensitivity means an output change amount of the drive motor according to a change of an opening level of an accelerator pedal.

15. The method of claim 13, wherein the control sensitivity in the rough road driving mode is set to be smaller than the control sensitivity in the muddy road driving mode, the control sensitivity in the normal driving mode, and the control sensitivity in the snowy road driving mode.

16. The method of claim 13, wherein the control sensitivity in the rough road driving mode is set to be greater than the control sensitivity in the muddy road driving mode, the control sensitivity in the normal driving mode, and the control sensitivity in the snowy road driving mode.

17. The method of claim 12, wherein in response that the driving mode is the rough road driving mode, an electronic stability control apparatus is turned off.
